(19) United States
(12) Patent Application Publication
(10) Pub. No.: US 2025/0384679 A1
(43) Pub. Date: Dec. 18, 2025

(54) CLASSIFIER-GUIDED DATASET COMPRESSION USING DISTRIBUTION-AWARE SELECTION

(71) Applicant: The Toronto-Dominion Bank, Toronto (CA)

(72) Inventors: Cheng Chang, Toronto (CA); Keyu Long, Toronto (CA); Ted Li, Toronto (CA); Himanshu Rai, Toronto (CA); Maksims Volkovs, Toronto (CA)

(73) Assignee: The Toronto-Dominion Bank, Toronto (CA)

(21) Appl. No.: 19/239,571

(22) Filed: Jun. 16, 2025

Related U.S. Application Data
(60) Provisional application No. 63/659,887, filed on Jun. 14, 2024.

(51) Int. Cl. G06V 10/82; G06V 10/74; G06V 10/77; G06V 10/771

(52) U.S. Cl. CPC G06V 10/82; G06V 10/761; G06V 10/771; G06V 10/7715

(57) ABSTRACT

An example operation may include at least one of determining, by a transformer encoder trained on annotated image-text data, first latents for a first dataset stored in a memory, and second latents for a second dataset stored in the memory, generating a similarity matrix based on comparisons between the first latents and the second latents, constructing a graph comprising nodes corresponding to the first latents and edges based on pairwise similarity exceeding a threshold, identifying connected components in the graph and selecting, from each component, at least one latent having a highest score from a classifier trained to approximate divergence between the first dataset and the second dataset, forming a reduced dataset comprising the at least one latent, providing the reduced dataset to a model training module, and training an image classifier using the reduced dataset and the second dataset.

### CROSS-REFERENCE TO RELATED APPLICATIONS

This application claims priority to U.S. Provisional Application No. 63/659,887, filed on Jun. 14, 2024, the entire disclosure of which is incorporated by reference herein.

This application is related via subject-matter to U.S. application Ser. No. 18/817,329, filed on Aug. 28, 2028, U.S. application Ser. No. 19/239,320, filed on Jun. 16, 2025, and U.S. application Ser. No. 19/239,431, filed on Jun. 16, 2025, the entire disclosures of which are incorporated by reference herein.

### BACKGROUND

Conventional machine learning systems often rely on full annotated datasets for training, leading to substantial computational overhead and inefficiencies in adapting to new or shifting target domains.

### SUMMARY

One example embodiment provides an apparatus that includes a memory; and at least one processor communicatively coupled to the memory, wherein the at least one processor is configured to perform at least one of: determine first latents for a first dataset stored in the memory and second latents for a second dataset stored in the memory that uses a transformer encoder trained on annotated image-text data, generate a similarity matrix based on comparisons between the first latents and the second latents, construct a graph comprising nodes that corresponds to the first latents and edges based on pairwise similarity that exceeds a threshold, identify connected components in the graph and select, from each component, at least one latent that has a highest score from a classifier trained to approximate divergence between the first dataset and the second dataset, form a reduced dataset comprising the at least one latent, provide the reduced dataset to a model training module, and train an image classifier that uses the reduced dataset and the second dataset.

Another example embodiment provides a method that includes at least one of determining, by a transformer encoder trained on annotated image-text data, first latents for a first dataset stored in a memory, and second latents for a second dataset stored in the memory, generating a similarity matrix based on comparisons between the first latents and the second latents, constructing a graph comprising nodes corresponding to the first latents and edges based on pairwise similarity exceeding a threshold, identifying connected components in the graph and selecting, from each component, at least one latent having a highest score from a classifier trained to approximate divergence between the first dataset and the second dataset, forming a reduced dataset comprising the at least one latent, providing the reduced dataset to a model training module, and training an image classifier using the reduced dataset and the second dataset.

A further example embodiment provides a computer readable storage medium comprising instructions, that when read by a processor, cause the processor to perform at least one of determining, by a transformer encoder trained on annotated image-text data, first latents for a first dataset stored in a memory, and second latents for a second dataset stored in the memory, generating a similarity matrix based on comparisons between the first latents and the second latents, constructing a graph comprising nodes corresponding to the first latents and edges based on pairwise similarity exceeding a threshold, identifying connected components in the graph and selecting, from each component, at least one latent having a highest score from a classifier trained to approximate divergence between the first dataset and the second dataset, forming a reduced dataset comprising the at least one latent, providing the reduced dataset to a model training module, and training an image classifier using the reduced dataset and the second dataset.

### BRIEF DESCRIPTION OF DRAWINGS

FIG. 1A is a system diagram for selecting and filtering training samples via latent similarity and distribution matching, according to examples and features of the instant solution.

FIG. 1B is a system diagram illustrating an operating environment of a software service, according to examples and features of the instant solution.

FIG. 2A is a system diagram illustrating integration of an artificial intelligence (AI) model into any decision point, according to the examples and features of the instant solution.

FIG. 2B is a diagram illustrating a process for developing an AI model that supports AI-assisted computer decision points, according to the examples and features of the instant solution.

FIG. 2C is a diagram illustrating a process for utilizing an AI model that supports AI-assisted computer decision points according to examples and features of the instant solution.

FIG. 2D is a system diagram illustrating a chatbot service that utilizes an AI model according to examples and features of the instant solution.

FIG. 3A is a system diagram illustrating an image classifier training according to examples and features of the instant solution.

FIG. 3B is a flow diagram illustrating an image classifier training according to examples and features of the instant solution.

FIG. 3C is a flow diagram illustrating a message processing through a chatbot system that encodes the input, applies latent similarity and divergence-based selection, classifies the message, and generates an adapted model response based on the classification outcome according to examples and features of the instant solution.

FIG. 4A is a flow diagram illustrating a method for classifier-guided dataset compression using distribution-aware selection, according to examples and features of the instant solution.

FIG. 4B is another flow diagram illustrating a method for classifier-guided dataset compression using distribution-aware selection, according to examples and features of the instant solution.

FIG. 5 is a system diagram illustrating a computing environment according to the instant solution's example features, structures, or characteristics.

### DETAILED DESCRIPTION

The instant solution relates to systems and methods for training image classification models using selectively reduced datasets derived from annotated image sources. More specifically, the instant solution addresses the problem of redundant and inefficient training data by introducing a structured selection process that reduces the size of an annotated dataset while preserving its representational value with respect to a target dataset.

Modern image classifiers rely on large-scale datasets for training, which often include significant overlap or redundancy among samples. This excess data can lead to increased computational costs and slower training cycles without proportionate gains in model performance. The instant solution provides a principled approach to pruning annotated datasets such that the most informative and statistically aligned examples are used during training.

The instant solution operates on a refined subset of annotated images that has already been filtered to approximate the distribution of a target dataset. Each image in this subset is encoded into a latent vector using a transformer-based model trained on image-text pairs. These latent representations serve as the basis for comparing image similarity.

To remove redundancy, a graph is constructed where each node corresponds to a latent vector, and edges are formed between nodes whose latent similarity exceeds a defined threshold. The resulting graph is partitioned into connected components, each representing a cluster of highly similar examples.

Within each component, a classifier, trained to model the divergence between the source (annotated) and target datasets, is applied to identify the sample most representative of the target domain. This selection process yields a new, reduced dataset containing one exemplar per connected component.

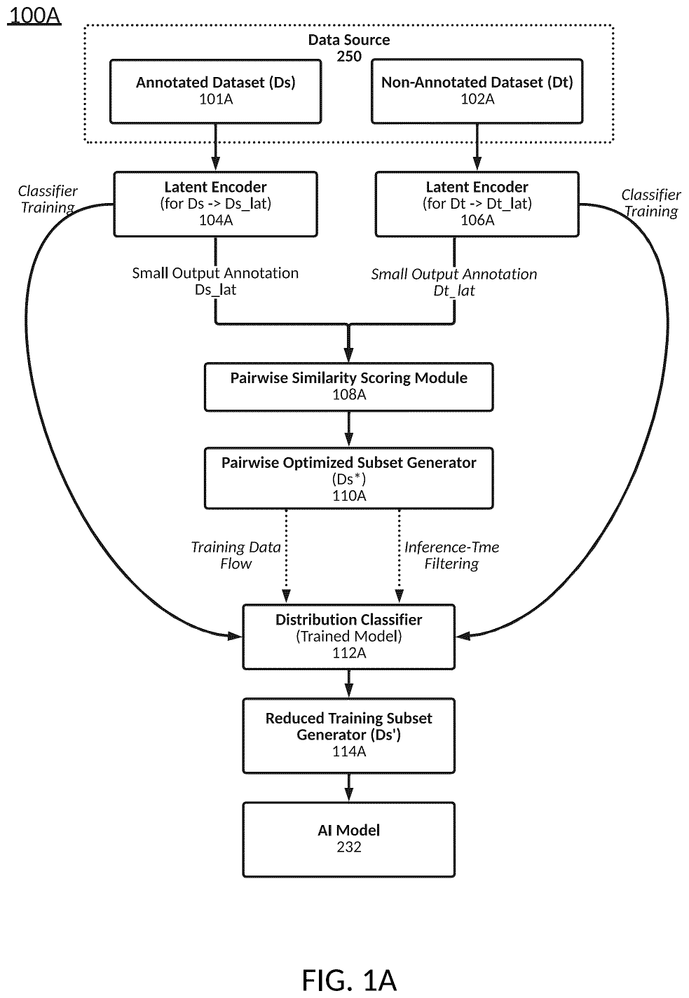

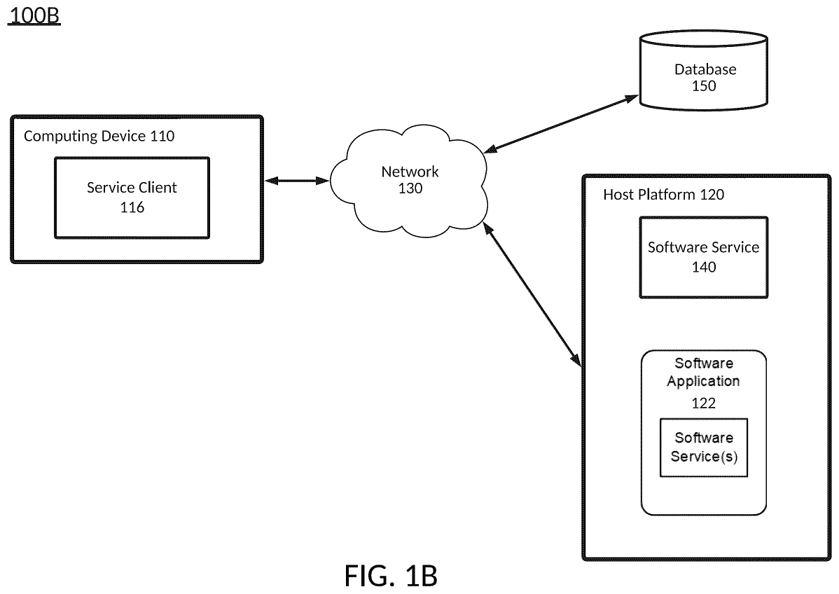

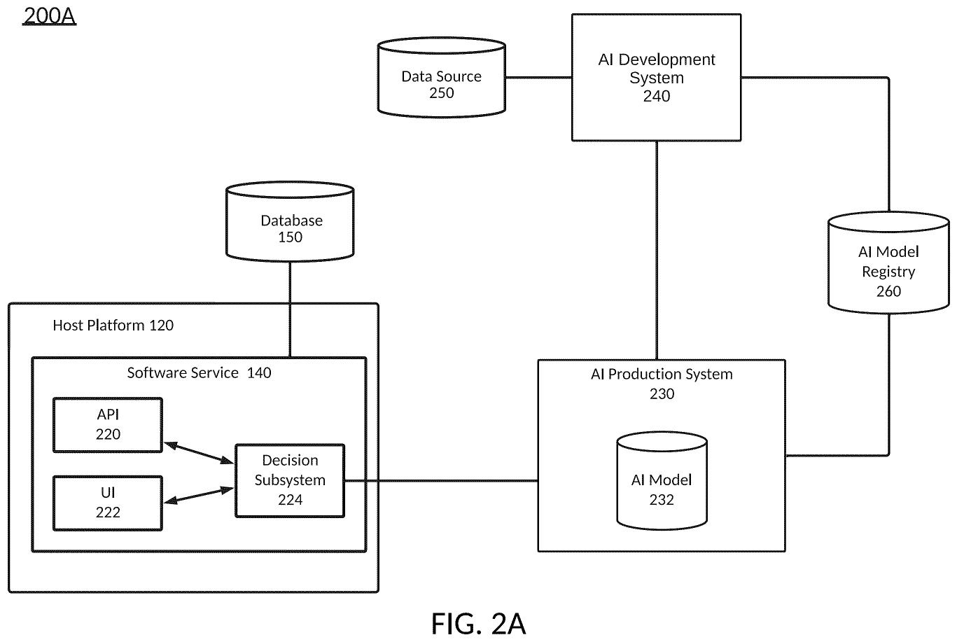

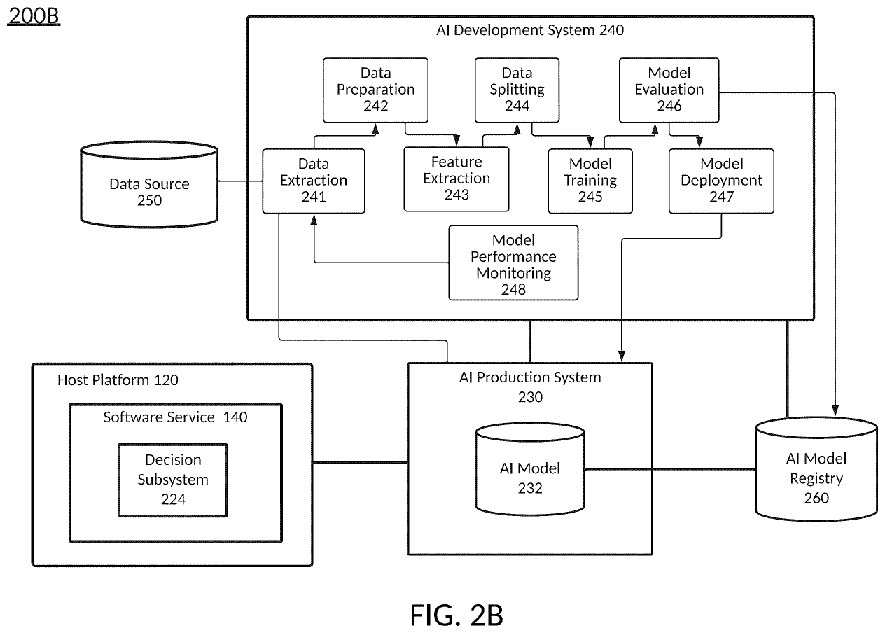

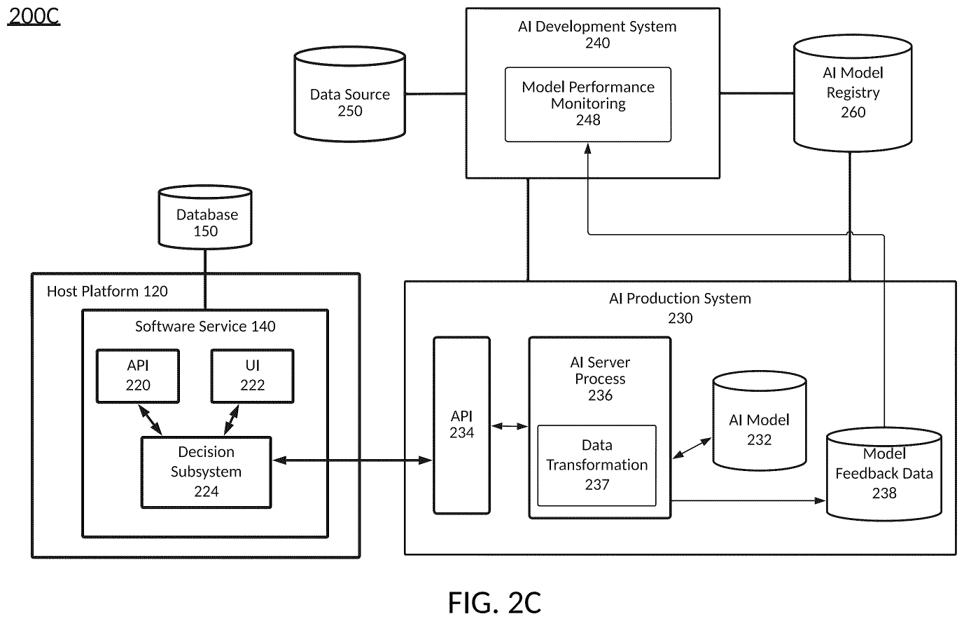

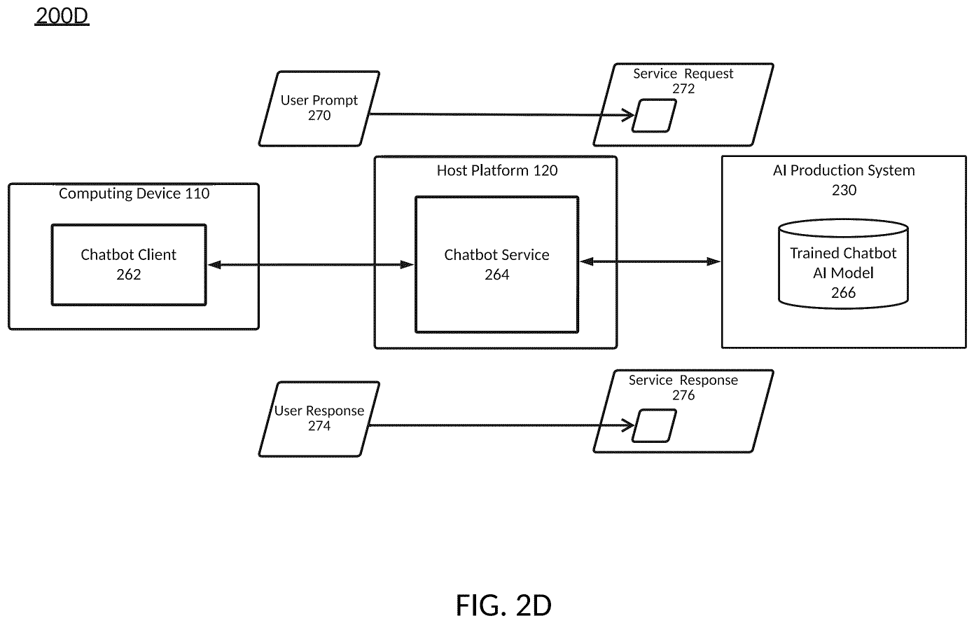

FIG. 1A is a system diagram 100A illustrating an example operating environment for the classifier-guided dataset compression using distribution-aware selection system of the instant solution. The system includes two data inputs: an annotated dataset 101A and a non-annotated dataset 102A. These datasets are examples of data sources 250 (see FIGS. 2A-2C), and may include labeled image collections, telemetry logs, domain-specific corpora, etc.

The annotated dataset 101A is processed by a latent encoder 104A to generate a first set of latent vectors (Ds_lat). Similarly, the non-annotated dataset 102A is encoded by latent encoder 106A to produce a second set of latent vectors (Dt_lat). The latent encoder 104A and 106A may each implement a vision transformer (ViT), ResNet, or other embedding models, and are examples of preprocessing modules used for feature extraction, consistent with data preparation 242 and feature extraction 243 in FIG. 2B.

The latent vectors Ds_lat and Dt_lat are provided to a pairwise similarity scoring module 108A, which computes similarity metrics across latents to facilitate alignment between domains. The output of the pairwise similarity scoring module 108A is used by a pairwise optimized subset generator 110A, which selects and retains the most similar latent samples from Ds_lat to produce an optimized intermediate subset Ds*. These components enable efficient domain transfer by aligning annotated samples with target distribution representations.

The subset Ds* is used as input to a distribution classifier 112A, which may be trained using both Ds_lat and Dt_lat. The distribution classifier 112A functions as a trained machine learning model for filtering and pruning semantically aligned examples. In some examples, distribution classifier 112A is deployed as or incorporated within AI model 232 (see FIGS. 2A-2C) during both development and inference stages.

The output of distribution classifier 112A is passed to a reduced training subset generator 114A, which outputs a final subset Ds′ of annotated data optimized for training. This subset reflects increased domain alignment with the non-annotated dataset 102A, while reducing redundant or low-value samples.

The final classifier is trained on Ds′ and deployed as inference engine, which is also an example of AI model 232 in production (see FIGS. 2A-2C). This inference engine supports downstream applications in the AI production system 230. During inference, it receives inputs from the non-annotated dataset 102A and performs classification tasks using a model that has been trained on a filtered, domain-adapted subset.

FIG. 1B is a system diagram 100B illustrating an example operating environment of the instant solution. As shown, at least one computing device 110 and a host platform 120 communicate via a network 130. The host platform 120 hosts a software service 140, which includes the core components depicted in FIG. 1B. The software service may reside in a software application 122. The software service 140 is responsible for executing a classifier-guided cluster optimization and deployment workflow. During execution, the software service 140 communicates with a database 150 for data access, model persistence, and retrieval operations.

Each computing device 110 may be a mobile phone, tablet, laptop computer, desktop computer, smartwatch, or infotainment system. These devices host a service client 116 that interfaces with the software service 140. The service client 116 may render graphical user interfaces or invoke the service via APIs, supporting workflow configurations or manual overrides. For example, a developer or data scientist using a service client 116 may initiate model training, initiate cluster reduction, or inspect similarity distributions based on feedback received from intermediate steps of the instant solution.

FIG. 2A illustrates an artificial intelligence (AI) network diagram 200A that supports AI-assisted decision points in a software service executing on a computer. While the example instant solution utilizes a neural network, which is a type of machine learning (ML) model, other branches of AI, such as, but not limited to, computer vision, fuzzy logic, expert systems, deep learning, generative AI, and natural language processing, may be employed in developing the AI model. Further, the AI model included in the instant solution is not limited to particular AI algorithms. Any algorithm or combination of algorithms related to supervised, unsupervised, or reinforcement learning may be employed.

The AI models, ML models, neural networks, and other branches of AI described herein build upon the fundamentals of predecessor technologies and form the foundation for future advancements in artificial intelligence. An AI classification system describes the stages of AI progression, including reactive machines, limited memory machines (also known as artificial narrow intelligence), theory of mind (artificial general intelligence), and self-aware systems (artificial superintelligence). Present-day limited memory machines are a growing group of AI models capable of learning from prior experience. In the instant solution, limited memory systems are employed to operate over latent encodings derived from annotated and non-annotated datasets to produce subset selections used for optimized training.

Examples of AI models classified as limited memory machines include chatbots, virtual assistants, ML models, deep neural networks, generative AI systems, and other present or future models possessing data-driven learning characteristics. The instant solution leverages these models to enable classifier-guided refinement of large datasets.

For example, a neural network used in the instant solution may process latent encodings to detect similarity between samples in a first dataset and a second dataset. Such neural network capabilities support the generation of subset data used in later classification stages and enable downstream training optimization and computational load reduction.

Generative AI models may also be used to encode input images into vector space latents as described in FIG. 1A. These encodings may serve as the basis for similarity comparisons and clustering. The instant solution applies trained classifiers to these encoded representations to generate a reduced training subset aligned with the distribution of the target dataset.

The AI models in the instant solution include at least one transformer-based latent encoder, at least one trained distribution classifier, and at least one object detection or classification model. These models form a collaborative system for similarity scoring, subset selection, and inference aligned with domain-specific divergence minimization. AI model 232, referenced in FIG. 2A, may correspond to any of the instant solution-trained models involved in reduced subset generation and inference deployment.

Software service 140, executing on host platform 120, may provide one or more APIs 220 to enable structured interactions with external software or data pipelines. In the instant solution, these APIs may receive input datasets, retrieve trained models from AI model registry 260, or submit image samples for classification using a reduced dataset. Each API 220 may initiate execution of one or more processing stages described in FIG. 1A. API requests and resulting outputs may be stored in database 150.

Software service 140 may also expose one or more user interfaces (UI) 222 for configuring clustering thresholds, reviewing classifier selection scores, or visualizing latent similarity distributions. The user interface may directly interact with decision subsystem 224, which is responsible for triggering the generation of the subset of the annotated dataset and the reduced training subset.

The decision subsystem 224 orchestrates execution of the instant solution by controlling data flow between latent encoders, similarity scoring modules, subset generators, and classifier filters. The decision subsystem may access previously stored annotations or non-annotated samples from database 150 and may initiate model calls within AI production system 230 for inference or retraining workflows.

AI production system 230 contains one or more AI models 232 used in the instant solution to classify images using the reduced training subset. AI model 232 may comprise an object detection network trained exclusively on the subset as produced in FIG. 1A. The AI production system may access this reduced training subset, stored in database 150, for real-time or batch classification of new inputs received from the non-annotated dataset. The production system may be hosted on-premises, cloud-based, or distributed.

AI development system 240 trains and maintains all components of the instant solution, including the latent encoders and the distribution classifier. Data from sources 250 may be ingested and transformed into vector representations suitable for training the classifier. The development system may run k-means clustering or construct similarity graphs to identify subset Ds* as described in FIG. 1A. Feedback from model inference may be looped back into this system for retraining.

Once training is complete, AI model 232 and the trained distribution classifier used in the instant solution are stored in AI model registry 260. The registry may serve models for inference and allow retrieval of clustering metadata or divergence metrics associated with the subset selection. The registry may be implemented as a distributed system or cloud-hosted repository and supports deployment across AI development and production systems.

FIG. 2B illustrates a process 200B for developing at least one AI model that supports AI-assisted decision points. An AI development system 240 executes steps to develop an AI model 232 that begins with data extraction 241, in which data is loaded and ingested from at least one data source 250. In some examples and features of the instant solution, historical model feedback data is extracted from at least one AI production system 230.

Once the data has been extracted during data extraction 241, it undergoes data preparation 242 for model training. In some examples and features of the instant solution, this step involves statistical testing of the data to see how well it reflects real-world events, its distribution, the variety of data in the dataset, etc., and the results of this statistical testing may lead to at least one data transformation being employed to normalize at least one value in the dataset. In some examples and features of the instant solution, data deemed to be noisy is cleaned. A noisy dataset includes values that do not contribute to the training, such as, but not limited to, null and long string values. Data preparation 242 may be a manual process or an automated process using at least one of the elements and/or functions described and/or depicted herein.

Features of the data are identified and extracted during the feature extraction step 243. In some examples and features of the instant solution, a feature of the data is internal to the prepared data from the data preparation step 242. In some examples and features of the instant solution, a feature of the data requires a piece of prepared data from the data preparation step 242 to be enriched by data from another data source to be useful in developing the AI model 232. In some examples and features of the instant solution, identifying features may be a manual process or an automated process using at least one of the elements and/or functions described and/or depicted herein. Once the features have been identified, the values of the features are collected into a dataset that will be used to develop the AI model 232.

The dataset output from the feature extraction step 243 is split 244 into a training and validation data set. The training data set is used to train the AI model 232, and the validation data set is used to evaluate the performance of the AI model 232 on unseen data.

The AI model 232 is trained and tuned 245 using the training data set from the data splitting step 244. In this step, the training data set is provided to an AI algorithm and an initial set of algorithm parameters. The performance of the AI model 232 is then tested within the AI development system 240 utilizing the validation data set from step 244. These steps may be repeated with adjustments to at least one algorithm parameter until the model's performance is acceptable based on various goals and/or results.

The AI model 232 is evaluated 246 in a staging environment (not shown) that resembles the target AI production system 230. This evaluation uses a validation dataset to ensure the performance in an AI production system 230 matches or exceeds expectations. In some examples and features of the instant solution, the validation dataset from step 244 is used. In some examples and features of the instant solution, at least one unseen validation dataset is used. In some examples and features of the instant solution, the staging environment is part of the AI development system 240, and the staging environment is managed separately from the AI development system 240. Once the AI model 232 has been validated, it is stored in an AI model registry 260, where it can be retrieved for deployment and future updates. In some examples and features of the instant solution, the model evaluation step 246 may be a manual process or an automated process using at least one of the elements and/or functions described and/or depicted herein.

In some examples and features of the instant solution, the AI development system includes a user interface (not shown). The user interface may be used to manage the development system infrastructure, the steps 241-248 within the development system, the interim data transmitted between the various steps 241-248, and the data sources 250.

Once an AI model 232 has been validated and published to an AI model registry 260, it may be deployed during the model deployment step 247 to at least one AI production system 230. In some examples and features of the instant solution, the performance of deployed AI model 232 is monitored 248 by the AI development system 240. In some examples and features of the instant solution, AI model 232 feedback data is provided by the AI production system 230 to enable model performance monitoring 248, and the AI development system 240 periodically requests feedback data for model performance monitoring 248, which includes at least one trigger that results in the AI model 232 being updated by repeating steps 241-248 with updated data from at least one data source 250.

In one example, an AI development system 240 is configured to process input data and train an AI model 232. The system receives data from at least one data source 250, and optionally one or more AI Production Systems 230, which may undergo a sequence of preprocessing steps before being used for training a predictive model. The AI development system 240 extracts data related to one or more of the instant features from at least one data source 250 in the data extraction 241. This extracted data is then processed through data preparation 242 to normalize or filter relevant information. Feature extraction 243 follows, where meaningful features are identified to increase model performance. The dataset is then split 244 into training and validation subsets.

The AI development system 240 (serving as a machine learning server) is directed to generate a predictive model based on machine learning of the data. The system initiates model training 245 using the prepared dataset. The AI development system 240 selects an appropriate machine learning algorithm and hyperparameters to optimize predictive accuracy. The trained model undergoes model evaluation 246 using validation data to assess performance. When the model meets predefined accuracy thresholds, it is deployed 247 to an AI production system 230 and registered in the AI model registry 260 for use in real-time decision-making.

The dataset produced during feature extraction step 243 may include latent representations derived from a transformer-based encoder trained on annotated image-text pairs. These latent vectors, generated from both curated annotated samples and incoming non-annotated data, serve as the foundation for a graph-based refinement process. The system constructs a similarity matrix between latent vectors, builds a graph with edges representing high-similarity connections, and identifies tightly connected clusters. A divergence classifier is applied to these clusters to select the most distribution-representative samples. This results in a reduced dataset that reflects the statistical characteristics of the target dataset while removing redundant or misaligned training examples.

The reduced dataset is passed to the training and tuning step 245, where it is combined with the target data and used to train an image classification model. Because the data has been pre-filtered for diversity and distribution alignment, the resulting model achieves increased generalization performance with reduced computational resources. The model then proceeds through evaluation in step 246 and, upon validation, is registered for deployment and reuse through the AI model registry 260. This integration of transformer-based latent encoding, similarity graph construction, and divergence-guided pruning into the AI development workflow supports faster training cycles, higher accuracy on domain-specific inputs, and adaptive retraining based on real-time feedback collected from production systems.

FIG. 2C illustrates a process 200C for utilizing an AI model that supports AI-assisted decision points. As stated previously, the AI model utilization process depicted herein reflects ML, which is a particular branch of AI, but this instant solution is not limited to ML and is not limited to any AI algorithm or combination of algorithms.

Referring to FIG. 2C, an AI production system 230 may be used by a decision subsystem 224 in software service 140 to assist in its decision-making process. The AI production system 230 provides an API 234, executed by an AI server process 236 through which requests can be made. In some examples and features of the instant solution, a request may include an AI model 232 identifier to be executed based on the type of request. In some examples and features of the instant solution, a data payload (e.g., to be input to the AI model during execution) is included in the request. The data payload may include API 220 data from software service 140, UI 222 data from software service 140 or data from other software service 140 subsystems (not shown).

Upon receiving the API 234 request, the AI server process 236 may transform 237 the data payload or portions of the data payload to be valid feature values in an AI model 232. Data transformation 237 may include, but is not limited to, combining data values, normalizing data values, and enriching the incoming data with data from other data sources 250. Once the data transformation occurs, the AI server process 236 executes the appropriate AI model 232 using the transformed input data. Upon receiving the execution result, the AI server process 236 responds to the API requester, which is a decision subsystem 224 of software service 140. In some examples and features of the instant solution, the response may result in an update to a UI 222 in software service 140. In some examples and features of the instant solution, the response includes a request identifier that can be used later by the software service 140 to provide feedback on the performance of the AI model 232. In some examples and features of the instant solution, a model feedback record may be added into a model feedback data 238 by the AI server process 236.

In some examples and features of the instant solution, the API 234 includes an interface to provide AI model 232 feedback after an AI model 232 execution response has been processed. This mechanism enables the requester to provide feedback on the accuracy of the AI model 232 results. In some examples and features of the instant solution, the feedback interface includes the identifier of the initial request so that it can be used to associate the feedback with the request. Upon receiving a call into the feedback interface of the API 234, the AI server process 236 creates and adds a model feedback record into the model feedback data 238 which holds historical model feedback records. In some examples and features of the instant solution, the records in this model feedback data 238 are provided to model performance monitoring 248 in the AI development system 240. This model feedback data is streamed to the AI development system 240 or may be provided upon request. In some examples and features of the instant solution, the model feedback records in the model feedback data 238 are used as an input for retraining the AI model 232.

Model retraining involves repeating steps 241-246 using the current data in the data source 250 along with the model feedback data 238. In some examples and features of the instant solution, the AI model 232 is retrained periodically as a matter business process in order to consider the latest data and/or retrained based on a trigger, such as, but not limited to, a recent model accuracy falling below a pre-determined threshold. In some examples and features of the instant solution, the model feedback data 238 is used as an input to determine the recent model accuracy.

In some examples and features of the instant solution, the AI production system 230 includes a user interface (not shown). The user interface may be used to manage the production system infrastructure, the components of the production system 230-238, and the operation of the AI production system and its components.

FIG. 2C illustrates a process 200C for utilizing an AI model that supports AI-assisted decision points. As stated previously, the AI model utilization process depicted herein reflects ML, which is a particular branch of AI, but this instant solution is not limited to ML and is not limited to any AI algorithm or combination of algorithms.

Referring to FIG. 2C, an AI production system 230 may be used by a decision subsystem 224 in software service 140 to assist in its decision-making process. The AI production system 230 provides an API 234, executed by an AI server process 236 through which requests can be made. In some examples and features of the instant solution, a request may include an AI model 232 identifier to be executed based on the type of request. In some examples and features of the instant solution, a data payload (e.g., to be input to the AI model during execution) is included in the request. The data payload may include API 220 data from software service 140, UI 222 data from software service 140 or data from other software service 140 subsystems (not shown).

Upon receiving the API 234 request, the AI server process 236 may transform 237 the data payload or portions of the data payload to be valid feature values in an AI model 232. Data transformation 237 may include, but is not limited to, combining data values, normalizing data values, and enriching the incoming data with data from other data sources 250. Once the data transformation occurs, the AI server process 236 executes the appropriate AI model 232 using the transformed input data. Upon receiving the execution result, the AI server process 236 responds to the API requester, which is a decision subsystem 224 of software service 140. In some examples and features of the instant solution, the response may result in an update to a UI 222 in software service 140. In some examples and features of the instant solution, the response includes a request identifier that can be used later by the software service 140 to provide feedback on the performance of the AI model 232. In some examples and features of the instant solution, a model feedback record may be added into a model feedback data 238 by the AI server process 236.

In some examples and features of the instant solution, the API 234 includes an interface to provide AI model 232 feedback after an AI model 232 execution response has been processed. This mechanism enables the requester to provide feedback on the accuracy of the AI model 232 results. The feedback interface may include the identifier of the initial request so that it can be used to associate the feedback with the request. Upon receiving a call into the feedback interface of the API 234, the AI server process 236 creates and adds a model feedback record into the model feedback data 238 which holds historical model feedback records. The records in this model feedback data 238 are provided to model performance monitoring 248 in the AI development system 240. This model feedback data is streamed to the AI development system 240 or may be provided upon request. The model feedback records in the model feedback data 238 are used as an input for retraining the AI model 232.

Model retraining involves repeating steps 241-246 using the current data in the data source 250 along with the model feedback data 238. In some examples and features of the instant solution, the AI model 232 is retrained periodically as a matter business process in order to consider the latest data and/or retrained based on a trigger, such as, but not limited to, a recent model accuracy falling below a pre-determined threshold. The model feedback data 238 is used as an input to determine the recent model accuracy. The AI production system 230 may include a user interface (not shown) which may be used to manage the production system infrastructure, the components of the production system 230-238, and the operation of the AI production system and its components.

FIG. 2D is a system diagram 200D illustrating a chatbot service that utilizes an AI model. Referring to FIG. 2D, a computing device 110 (see FIGS. 1B, 2D) may host a chatbot client 262 which interworks with a chatbot service 264 executing on a host platform 120 (see FIGS. 1B, 2D). Further, the chatbot service 264 utilizes a trained chatbot AI model 266 that is resident on an AI production system 230 (see FIGS. 2A-2D). In some examples and features of the instant solution, the chatbot client 262 is an example of a service client 116, depicted in FIG. 1B. In some examples and features of the instant solution, the chatbot service 264 is an example of software service 140 (see FIG. 2A) which includes an API 220 (see FIG. 2A), a UI 222 (see FIG. 2A) and at least one decision subsystem 224 (see FIG. 2A). In some examples and features of the instant solution, the trained chatbot AI model 266 is an example of AI model 232 (see FIGS. 2A-2C) which is hosted on an AI production system 230 (see FIGS. 2A-2D). In some examples and features of the instant solution, the AI production system 230 (see FIG. 2D) includes the internal architectural elements depicted in FIG. 2C.

The chatbot client 262 accepts and captures a user prompt 270 which it sends to the chatbot service 264. Upon receiving the user prompt 270, the chatbot service 264 builds a service request 272 that includes the user prompt 270. In some examples and features of the instant solution, the service request 272 may include a target AI model identifier, such as an identifier to a trained chatbot AI model 266. Once built, the service request 272 is delivered to the AI production system 230 (see FIGS. 2A-2D). Upon receipt of the service request 272, the AI production system 230 determines the target AI model, such as the trained chatbot AI model 266, and extracts the user prompt 270. In some examples and features of the instant solution, the AI production system transforms the user prompt 270 using natural language understanding (NLU) or natural language processing (NLP) techniques before delivering it to the trained chatbot AI model 266. Upon receipt of the possibly transformed user prompt 270, the trained chatbot AI model 266 determines an appropriate user response 274 and returns the user response 274 to the AI production system 230. In some examples and features of the instant solution, the trained chatbot AI model 266 utilizes neural networks or natural language generation (NLG) techniques in order to determine the appropriate user response 274.

Upon receipt of the response, the AI production system 230 constructs and sends a service response 276 that contains the user response 274 back to the chatbot service 264. Upon receipt of the service response 276, the chatbot service 264 extracts the user response 274 and delivers it to the chatbot client 262, which emits it.

The chatbot service 264 may interact with auxiliary AI models, hosted on AI production system 230, to perform classification tasks prior to or in conjunction with generating a response. When user prompt 270 is received at the chatbot service, it may be encoded into a latent representation using a transformer-based encoder co-resident with or accessible to trained chatbot AI model 266. This latent representation may be evaluated against a stored reduced dataset, previously generated using a similarity graph constructed from annotated latent samples, to determine how closely the prompt aligns with known patterns. The reduced dataset is formed by identifying latent clusters through pairwise similarity scoring and selecting representative samples using a divergence-based classifier trained to differentiate between annotated and target prompt distributions.

As part of this classification workflow, AI production system 230 may use internal services depicted in FIG. 2C, such as data transformation 237 and feedback collection in model feedback data 238, to refine input prompts or to adjust system behavior. For example, a prompt classified as containing sensitive content or out-of-distribution context may alter the selection logic used by trained chatbot AI model 266, causing it to retrieve responses from a constrained generation set or to trigger a moderation-specific routing policy. The chatbot service 264, upon receiving the generated user response 274 from the production system, assembles service response 276 and delivers it back to chatbot client 262. The instant solution leverages the classifier-guided subset reduction methodology to reduce model complexity, increase inference efficiency, and maintain accuracy across evolving language input patterns received through user prompts 270.

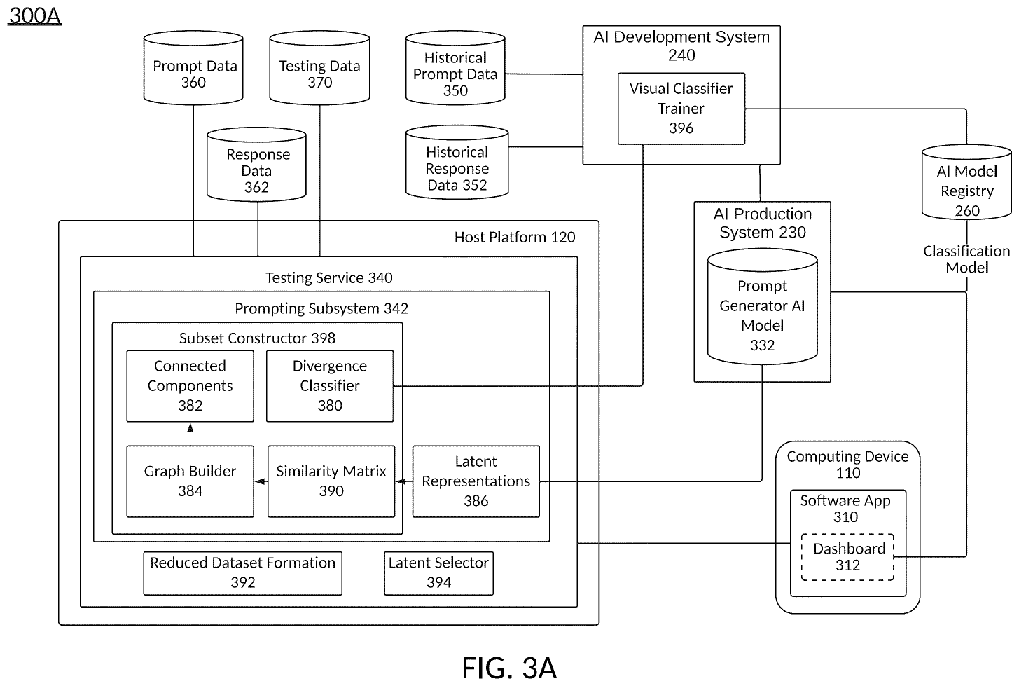

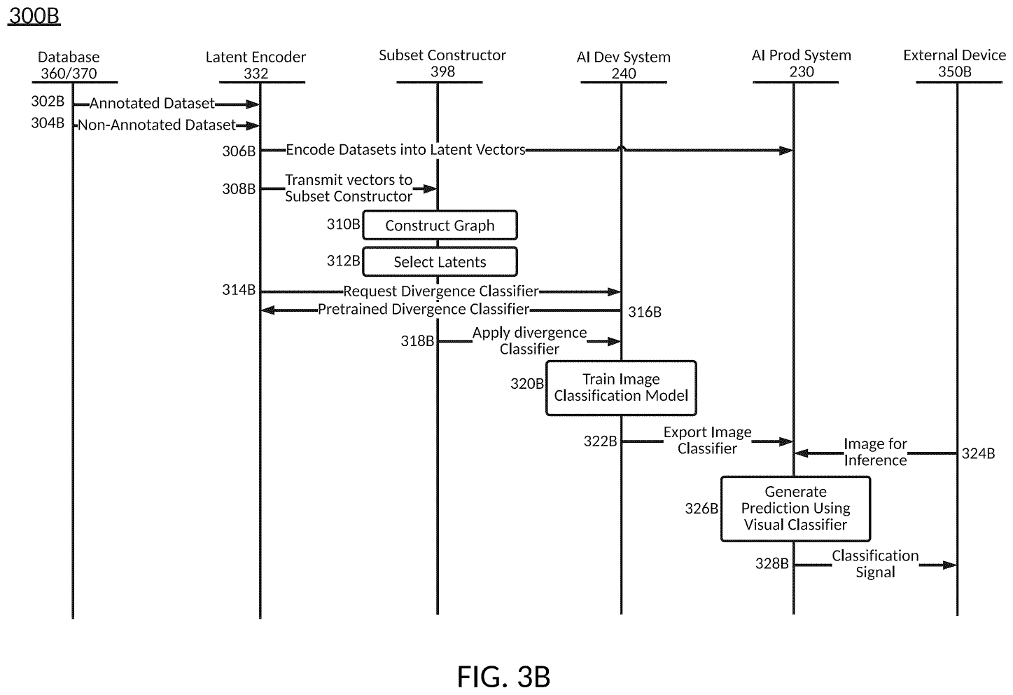

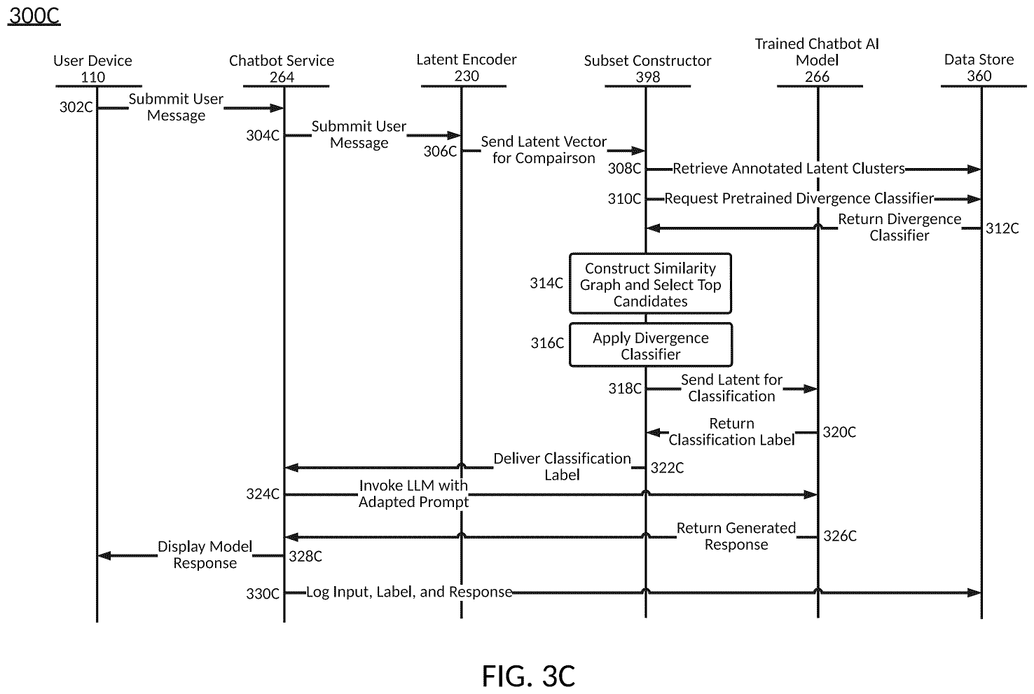

FIG. 3A is a system diagram illustrating an operating environment 300A for a latent-driven classifier optimization service. This service generates and trains an image classification model by selecting a reduced, domain-representative subset of annotated data using latent similarity scoring and divergence-based filtering.

A visual classifier model (AI model 232) is trained using multiple data sources, including prompt data 360, testing data 370, historical prompt data 350, response data 362, and historical response data 352. These datasets represent a combination of labeled and unlabeled examples used for latent encoding, graph construction, subset optimization, and final model training. These data sources correspond to the data source 250 identified in FIGS. 2A through 2C.

The data pipeline begins with the latent encoder 332, hosted within AI production system 230, which encodes image-text pairs into dense latent vectors. These latent representations are forwarded to the latent representations 386, residing within the prompting subsystem 342 under testing service 340, running on host platform 120.

To compare samples between annotated and target datasets, the similarity matrix 390 computes pairwise similarity scores between their respective latent vectors. These scores are passed to the graph builder 384, which constructs a graph where nodes correspond to latent vectors and edges represent high similarity links, as defined by a configurable threshold.

Graph topology is analyzed by connected components 382, which identifies clusters of related latents within the similarity graph. For each connected component, the divergence classifier 380 assigns a divergence score indicating how well each sample represents the statistical distribution of the target dataset. Based on this scoring, the latent selector 394 chooses one or more high-quality representative samples from each cluster.

Selected samples are collected and packaged by reduced dataset formation 392, producing a curated subset of the annotated dataset that is optimized for training accuracy and distributional coverage. This reduced dataset is transferred to AI development system 240, where visual classifier trainer 396 uses it, along with the original testing data, to train the final version of the AI model 232. Once trained, the model is registered in AI model registry 260 for deployment and future use.

The classifier is deployed into AI production system 230 for real-time or batch inference tasks. It becomes callable by upstream services such as a latent-driven classifier optimization pipeline or chatbot logic, as shown in FIGS. 2C and 2D.

A user-facing software app 310 installed on computing device 110 provides a dashboard 312 interface that allows users to upload data, view classifier outputs, submit feedback, and adjust classification settings. Data submitted through the app may include image files, metadata tags, label suggestions, and time or location context.

Submitted data is transmitted to the host platform and routed through the latent encoder 332 for encoding. The resulting latent is evaluated against previously constructed graphs and scoring systems maintained by prompting subsystem 342. The classifier output is then returned to the dashboard for user review.

Device-level data from computing device 110, such as MAC address and IP address, may also be collected to support access control, context-aware adjustments, or user segmentation in the classification workflow.

When user input is processed, subset constructor 398 activates the full optimization pipeline. This includes graph generation, cluster detection, divergence filtering, and reduced dataset formation. This component is functionally aligned with the decision subsystem 224 introduced in FIGS. 2A through 2C.

The classifier system continues to operate as new data arrives. New samples may trigger periodic updates to the similarity graph and divergence classifier, supporting adaptive retraining and continuous learning. As shown in FIG. 2C, the data transformation process 237 ensures that input samples are converted into feature vectors aligned with the classifier's input schema.

Once predictions are generated, they are returned to the software app and displayed through dashboard 312 interface. Users may provide feedback directly from the interface, which is stored in a feedback log corresponding to the model feedback data 238 component in FIG. 2C. This feedback supports ongoing retraining and model monitoring efforts.

Additional AI models, such as content-type classifiers, anomaly detectors, or moderation filters, can be integrated into the same environment. These models may operate on top of the latent representations, using either the full annotated dataset or the reduced set derived by the optimization pipeline.

Multiple decision subsystems can operate concurrently, handling different aspects of system logic such as label routing, post-processing, or threshold-based overrides. These decision subsystems extend the core architecture into domain-specific deployments such as document triage, image moderation, or support classification.

The system may also leverage third-party data sources and public model APIs to enrich latent comparisons or support model explainability. Examples include image-tagging services, open-domain image corpora, and contextual graph embeddings.

Classifier outputs may be used by the software app to power live predictions, annotate external datasets, or trigger external systems.

FIG. 3B is a sequence diagram 300B illustrating the execution flow of a latent-guided classifier training and inference pipeline implemented across modular system components. The figure highlights the coordination between data storage, latent encoding, subset construction, model training, deployment, and downstream classification.

The process begins at the database, which includes both an annotated dataset in prompt data 360 and a non-annotated dataset in testing data 370. These datasets are read and passed to the latent encoder 332. The annotated dataset is sent at step 302B, and the non-annotated dataset is sent at step 304B. The encoder, implemented as a transformer model, processes and encodes both datasets into latent vector representations 306B. These representations preserve semantic and visual characteristics of the original inputs in a compressed feature space suitable for similarity analysis.

Once encoded, the latent encoder transmits the vectors 308B to the subset constructor 398. The subset constructor orchestrates the selection of an optimal reduced dataset. First, it constructs a similarity graph 310B using pairwise latent comparisons, where nodes represent source latents and edges connect nodes with similarity exceeding a predefined threshold. Then, the system identifies connected components within the graph and selects latents 312B that are most representative from each component.

To perform domain-aware selection, the subset constructor initiates a request for a pretrained divergence classifier 314B from the AI development system 240. The AI development system returns a pretrained divergence classifier 316B that has been trained to distinguish distributions between the annotated and non-annotated datasets. The subset constructor applies the divergence classifier 318B to select samples that are statistically aligned with the target distribution.

The selected latents are used to train an image classification model 320B. This training is performed by a classifier training module within the subset constructor, or optionally by the AI development system. Once the model is trained, it exports the image classifier 322B to the AI production system 230 for use in inference workflows.

After deployment, the visual classifier is used to process inference data submitted from external device 350B. When an image is received in step 324B, the classifier is invoked to generate a prediction using the visual classifier 326B. This prediction, returned as a classification signal 328B, may be used for routing, moderation, or domain-specific decision-making.

FIG. 3B complements the architectural layout provided in FIG. 3A by revealing the timing and handoff between systems in the data refinement and classification cycle. The subset constructor 398 matches the decision logic encapsulated in prompting subsystem 342. The classifier training and inference operations rely on components of AI development system 240 and AI production system 230, and final deployment supports external consumption, such as through chatbot services or real-time image classification endpoints.

FIG. 3B illustrates a system-driven workflow for constructing a domain-aligned training dataset through latent-based similarity and divergence analysis. The process begins with retrieval of two datasets: an annotated dataset from prompt data database 360 and a non-annotated dataset from testing data database 370. These datasets are stored in a shared database and loaded into a latent encoder 332, which may include a vision transformer (ViT) model trained on image-text data, such as a CLIP architecture. The encoder transforms each image into a latent vector representation that captures the semantic and visual features of the input images. The annotated images are encoded into a first set of latents, and the non-annotated images into a second set of latents.

Once encoded, the latent vectors are sent to a subset constructor 398 for comparative processing. The subset constructor analyzes the similarity between the first and second latent sets and builds a similarity matrix using pairwise similarity metrics. This data may be used to construct a similarity graph in which nodes represent latents and edges connect samples with similarity scores above a threshold. In some configurations, clustering techniques such as k-means are used to identify groupings of similar latents, from which representative samples are selected.

A preliminary subset of the annotated dataset is then formed by selecting latent samples that are most similar to those from the non-annotated dataset. This reduces redundancy in the original annotated dataset while ensuring that retained samples closely resemble the distribution of the target domain. This subset is further refined by applying a pretrained divergence classifier, which is retrieved from an AI development system 240 and applied within the subset constructor. The divergence classifier has been trained to distinguish between distributions of annotated and non-annotated data and is used to filter the subset to retain samples that are aligned with the target distribution.

Once the reduced training set is finalized, it is passed to a training engine at step 320B. A classification model, such as an object detection or image categorization model, is trained using the reduced annotated dataset, in combination with unannotated examples for validation or augmentation. After training, the model is exported to an AI production system 230, where it is deployed for inference tasks.

New input images from an external device 350B are processed by the deployed classifier, which generates predictions using the features learned from the reduced dataset. This workflow increases efficiency by minimizing computational overhead associated with large, redundant datasets, while preserving the accuracy and generalizability of the trained model.

FIG. 3C is a sequence diagram 300C illustrating how a chatbot system utilizes latent vector analysis and divergence-based classification to enhance message understanding and response generation. The system integrates components from both the data processing and inference pipelines previously introduced in FIGS. 3A and 3B.

The process begins when a user operating on computing device 110 submits a user message 302C to the system. This message is received by chatbot service 264, which operates on a backend host platform responsible for orchestrating conversational processing workflows and submits the user message 304C to the latent encoder 332, where it is transformed into a latent vector representation using a pretrained transformer-based model. This encoding captures semantic and contextual properties of the message while mapping it into a high-dimensional feature space.

The latent encoder sends the latent vector for comparison 306C to the subset constructor 398 for evaluation. The subset constructor is responsible for comparing the input latent against a distribution of previously annotated latent clusters. To do this, it first retrieves annotated latent clusters 308C from data store and simultaneously requests a pretrained divergence classifier 310C from trained chatbot AI model 266. These resources are used to determine which annotated samples most closely match the characteristics of the incoming latent. The classifier and latent data are returned in step 312C.

With the latent clusters and classifier in place, the subset constructor 398 executes graph-based logic to construct a similarity graph and select top candidates 314C reference samples. These candidates are evaluated applying the divergence classifier 316C to assess their relevance to the input latent vector. Once the most appropriate reference is identified, the input latent is sent for classification 318C and the classification label is returned 320C to the subset constructor 398.

The subset constructor delivers the classification label 322C to the chatbot service 264. This label can represent intent classification, domain assignment, moderation category, or other contextual cues. The chatbot service uses this label to select or construct a prompt that is aligned with the user's intent. The chatbot service invokes a large language model (LLM) or generative engine with the adapted prompt 324C within the chatbot stack for final response generation.

The generated response is returned 326C to the chatbot service and sent to the computing device 110 to display the model response 328C. In parallel, the input message, classification label, and generated response are logged 330C for downstream analysis or retraining purposes. This log may feed into model feedback workflows as described in FIG. 2C and connected to systems such as model feedback data 238.

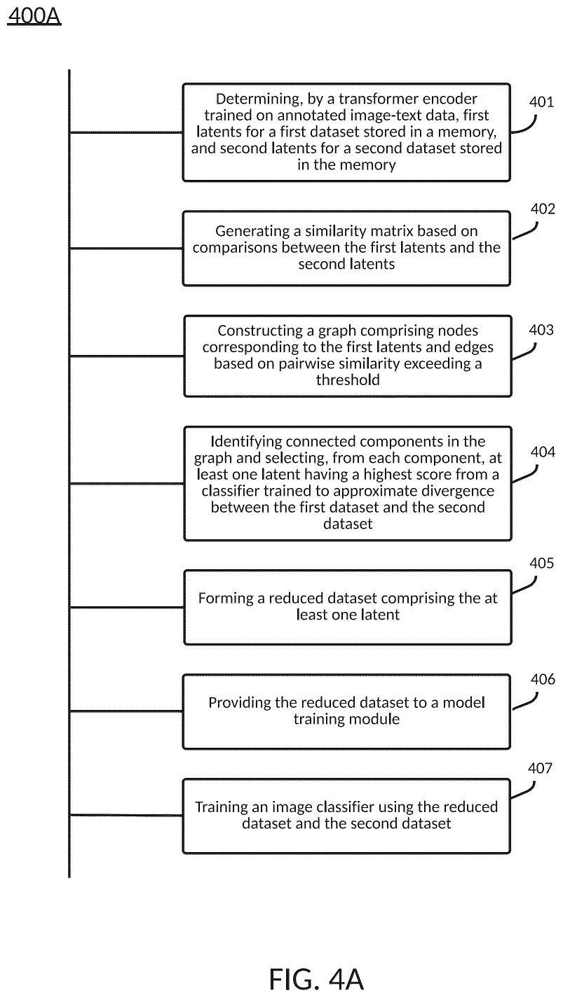

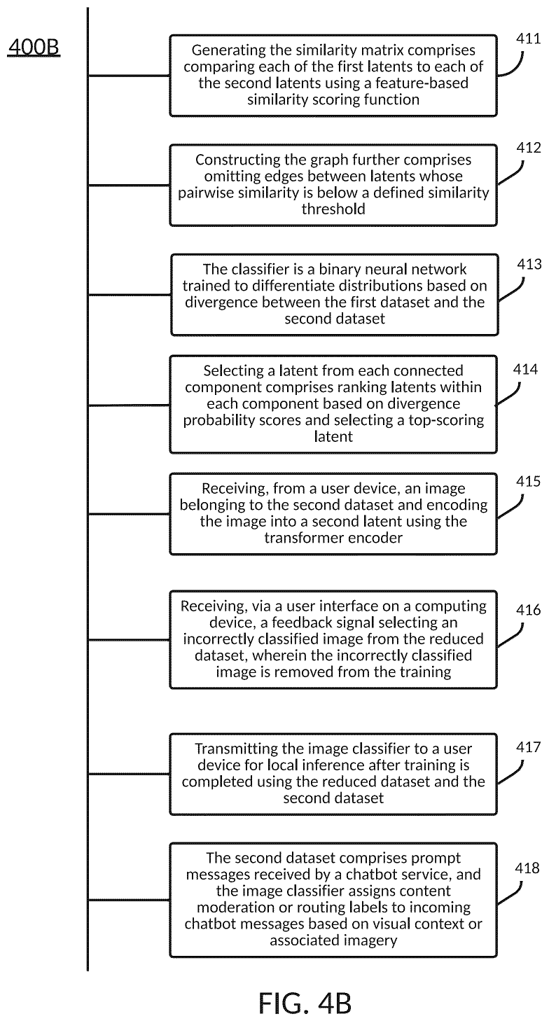

FIG. 4A illustrates an example of a method 400A for classifier-guided dataset compression using distribution-aware selection according to examples and features of the instant solution. As an example, the method 400A may be performed by a computing system, a software application, a server, a cloud platform, a combination of systems, and the like. Referring to FIG. 4A, in 401, the method may include determining, by a transformer encoder trained on annotated image-text data, first latents for a first dataset stored in a memory, and second latents for a second dataset stored in the memory. In 402, the method may include generating a similarity matrix based on comparisons between the first latents and the second latents. In 403, the method may include constructing a graph comprising nodes corresponding to the first latents and edges based on pairwise similarity exceeding a threshold. In 404, the method may include identifying connected components in the graph and selecting, from each component, at least one latent having a highest score from a classifier trained to approximate divergence between the first dataset and the second dataset. In 405, the method may include forming a reduced dataset comprising the at least one latent. In 406, the method may include providing the reduced dataset to a model training module. In 407, the method may include training an image classifier using the reduced dataset and the second dataset.

FIG. 4B illustrates a method 400B for classifier-guided dataset compression using distribution-aware selection according to other examples and features of the instant solution. As an example, the method 400B may be performed by a computing system, a software application, a server, a cloud platform, a combination of systems, and the like. Referring to FIG. 4B, in 411, the method may include generating the similarity matrix comprising comparing each of the first latents to each of the second latents using a feature-based similarity scoring function. In 412, the method may include constructing the graph further comprises omitting edges between latents whose pairwise similarity is below a defined similarity threshold. In 413, the method may include the classifier being a binary neural network trained to differentiate distributions based on divergence between the first dataset and the second dataset. In 414, the method may include selecting a latent from each connected component comprises ranking latents within each component based on divergence probability scores and selecting a top-scoring latent. In 415, the method may include receiving, from a user device, an image belonging to the second dataset and encoding the image into a second latent using the transformer encoder. In 416, the method may include receiving, via a user interface on a computing device, a feedback signal selecting an incorrectly classified image from the reduced dataset, wherein the incorrectly classified image is removed from the training. In 417, the method may include transmitting the image classifier to a user device for local inference after training is completed using the reduced dataset and the second dataset. In 418, the method may include the second dataset comprising prompt messages received by a chatbot service, and the image classifier assigns content moderation or routing labels to incoming chatbot messages based on visual context or associated imagery.

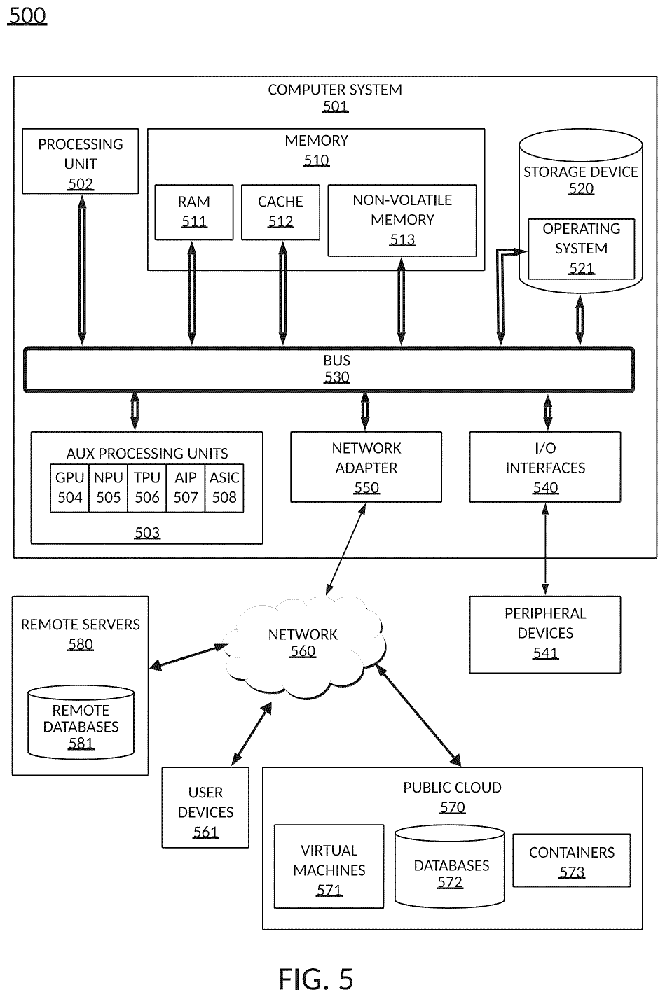

The examples and features of the instant solution may be implemented in at least one of the elements described or depicted herein, including for example, the elements described or depicted in FIG. 5. These examples and features may further be implemented in hardware, in a computer program executed by a processor, in firmware, or in a combination of the above. A computer program may be embodied on a computer readable medium, such as a storage medium. For example, a computer program may reside in random access memory (RAM), flash memory, read-memory (ROM), erasable programmable read-memory (EPROM), electrically erasable programmable read-memory (EEPROM), registers, hard disk, a removable disk, a compact disk read-memory (CD-ROM), or any other form of storage medium known in the art.

An exemplary storage medium may be communicatively coupled to the processor such that the processor may read information from, and write information to, the storage medium. In the alternative, the storage medium may be integral to the processor. The processor and the storage medium may reside in an application specific integrated circuit (ASIC). In the alternative, the processor and the storage medium may reside as discrete components. For example, FIG. 5 illustrates an example computer system architecture, which may represent or be integrated in any of the above-described components, etc.

FIG. 5 illustrates a computing environment according to the instant solution's example features, structures, or characteristics. FIG. 5 is not intended to suggest any limitation as to the scope of use or functionality of features, structures, or characteristics of the instant solution of the application described herein. Regardless, the computing environment 500 can be implemented to perform any of the functionalities described herein. In computing environment 500, there is a computer system 501, operational within numerous other general-purpose or special-purpose computing system environments or configurations.

Computer system 501 may take the form of a desktop computer, laptop computer, tablet computer, smartphone, smartwatch or other wearable computer, server computer system, thin client, thick client, network computer system, minicomputer system, mainframe computer, quantum computer, and distributed cloud computing environment that include any of the described systems or devices, and the like or any other form of computer or mobile device now known or to be developed in the future that is capable of running a program, accessing a network 560 or querying a database. Depending upon the technology, the performance of a computer-implemented method may be distributed among multiple computers and among multiple locations. However, in this presentation of the computing environment 500, a detailed discussion is focused on a single computer, specifically computer system 501, to keep the presentation as simple as possible.

Computer system 501 may be located in a cloud, even though it is not shown in a cloud in FIG. 5. On the other hand, computer system 501 may not be in a cloud except to any extent as may be affirmatively indicated. Computer system 501 may be described in the general context of computer system-executable instructions, such as program modules, executed by a computer system 501. Generally, program modules may include routines, programs, objects, components, logic, data structures, and so on that perform tasks or implement certain abstract data types. As shown in FIG. 5, computer system 501 in computing environment 500 is shown in the form of a general-purpose computing device. The components of computer system 501 may include but are not limited to, at least one processor or processing unit 502, a system memory 510, and a bus 530 that couples various system components, including system memory 510 to processing unit 502.

Processing unit 502 includes at least one computer processor of any type now known or to be developed. The processing unit 502 may contain circuitry distributed over multiple integrated circuit chips. The processing unit 502 may also implement multiple processor threads and multiple processor cores. Cache 512 is a memory that may be in the processor chip package(s) or located “off-chip,” as depicted in FIG. 5. Cache 512 is typically used for data or code accessed by the threads or cores running on the processing unit 502. In some computing environments, processing unit 502 may be designed to work with qubits and perform quantum computing.

The Auxiliary Processing Units (APU) 503 may contain at least one Graphics Processing Unit (GPU) 504, Neural Processing Unit (NPU) 505, Tensor Processing Unit (TPU) 506, AI Processor (AIP) 507, or other Application Specific Integrated Circuit (ASIC) 508. The at least one APU 503 may contain circuitry distributed over multiple integrated circuit chips. Each APU 503 may implement multiple processor threads and multiple processor cores. Each APU 503 may include at least one of onboard memory, onboard memory cache, and onboard instruction cache. Each APU may be communicatively coupled to the system bus 530 and configure to communicate with other system components, including a processing unit 502, system cache 512, RAM 511, non-volatile RAM 513, operating system 521, Network adapter 550, and Input/Output interfaces 540. In some computing environments, at least one of the at least one APU 503 may be designed to work with qubits and perform quantum computing.

Memory 510 is any volatile memory now known or to be developed in the future. Examples include dynamic random-access memory (RAM) 511 or static type RAM 511. Typically, the volatile memory is characterized by random access, but this may not be the characterization unless affirmatively indicated. In computer system 501, memory 510 is in a single package. It is internal to computer system 501, but alternatively or additionally, the volatile memory may be distributed over multiple packages and/or located externally with respect to computer system 501. By way of example, memory 510 can be provided for reading from and writing to a non-removable, non-volatile magnetic media (shown as storage device 520, and typically called a “hard drive”). Memory 510 may include at least one program product having a set (e.g., at least one) of program modules configured to carry out the functions of various features, structures, or characteristics of the instant solution of the application. A typical computer system 501 may include cache 512, a specialized volatile memory generally faster than RAM 511 and generally located closer to the processing unit 502. Cache 512 stores frequently accessed data and instructions accessed by the processing unit 502 to speed up processing time. The computer system 501 may also include non-volatile memory 513 in the form of ROM, PROM, EEPROM, and flash memory. Non-volatile memory 513 often contains programming instructions for starting the computer, including the basic input/output system (BIOS) and information to start the operating system 521.

Computer system 501 may include a removable/non-removable, volatile/non-volatile computer storage device 520. For example, storage device 520 can be a non-removable, non-volatile magnetic media (not shown and typically called a “hard drive”). At least one data interface can connect it to the bus 530. In features, structures, or characteristics of the instant solution where computer system 501 has a large amount of storage (for example, where computer system 501 locally stores and manages a large database), then this storage may be provided by peripheral storage devices 520 designed for storing very large amounts of data, such as a storage area network (SAN) that is shared by multiple, geographically distributed computers.

The operating system 521 is software that manages computer system 501 hardware resources and provides common services for computer programs. Operating system 521 may take several forms, such as various known proprietary operating systems or open-source Portable Operating System Interface type operating systems that employ a kernel.

The bus 530 represents at least one of several types of bus structures, including a memory bus or memory controller, a peripheral bus, an accelerated graphics port, and a processor or local bus using various bus architectures. By way of example, and not limitation, such architectures include Industry Standard Architecture (ISA) buses, Micro Channel Architecture (MCA) buses, Enhanced ISA (EISA) buses, Video Electronics Standards Association (VESA) local buses, and Peripheral Component Interconnect (PCI) bus. The bus 530 is the signal conduction path that allows the various components of computer system 501 to communicate.

Computer system 501 may communicate with at least one peripheral device, 541, via an input/output (I/O) interface, 540. Such devices may include a keyboard, a pointing device, a display, etc.; at least one device that enables a user to interact with computer system 501; and/or any devices (e.g., network card, modem, etc.) that enable computer system 501 to communicate with at least one other computing device. Such communication can occur via I/O interface 540. As depicted, I/O interface 540 communicates with the other components of computer system 501 via bus 530.

Network adapter 550 enables the computer system 501 to connect and communicate with at least one network 560, such as a local area network (LAN), a wide area network (WAN), and/or a public network (e.g., the Internet). It bridges the computer's internal bus 530 and the external network, exchanging data efficiently and reliably. The network adapter 550 may include hardware, such as modems or Wi-Fi signal transceivers, and software for packetizing and/or de-packetizing data for communication network transmission. Network adapter 550 supports various communication protocols to ensure compatibility with network standards. Ethernet connections adhere to protocols such as IEEE 802.3, while wireless communications might support IEEE 802.11 standards, Bluetooth, near-field communication (NFC), or other network wireless radio standards.

Network 560 is any computer network that can receive and/or transmit data. Network 560 can include a WAN, LAN, private cloud, or public Internet, capable of communicating computer data over non-local distances by any technology that is now known or to be developed in the future. Any connection depicted can be wired and/or wireless and may traverse other components that are not shown. In some features, structures, or characteristics of the instant solution, a network 560 may be replaced and/or supplemented by LANs designed to communicate data between devices in a local area, such as a Wi-Fi network. The network 560 typically includes computer hardware such as copper transmission cables, optical transmission fibers, wireless transmission, routers, firewalls, switches, gateway computers, edge servers, and network infrastructure known now or to be developed in the future. Computer system 501 connects to network 560 via network adapter 550 and bus 530.

User devices 561 are any computer systems used and controlled by an end user in connection with computer system 501. For example, in a hypothetical case where computer system 501 is designed to provide a recommendation to an end user, this recommendation may typically be communicated from network adapter 550 of computer system 501 through network 560 to a user device 561, allowing user device 561 to display, or otherwise present, the recommendation to an end user. User devices can be a wide array, including personal computers, laptops, tablets, hand-held, mobile phones, etc.

A public cloud 570 is an on-demand availability of computer system resources, including data storage and computing power, without direct active management by the user. Public clouds 570 are often distributed, with data centers in multiple locations for availability and performance. Computing resources on public clouds 570 are shared across multiple tenants through virtual computing environments comprising virtual machines 571, databases 572, containers 573, and other resources. A container 573 is an isolated, lightweight software for running a software application on the host operating system 521. Containers 573 are built on top of the host operating system's kernel and contain software applications and some lightweight operating system APIs and services. In contrast, virtual machine 571 is a software layer with an operating system 521 and kernel. Virtual machines 571 are built on top of a hypervisor emulation layer designed to abstract a host computer's hardware from the operating software environment. Public clouds 570 generally offers databases 572, abstracting high-level database management activities. At least one element described or depicted in FIG. 5 can perform at least one of the actions, functionalities, or features described or depicted herein.

Remote servers 580 are any computers that serve at least some data and/or functionality over a network 560, for example, WAN, a virtual private network (VPN), a private cloud, or via the Internet to computer system 501. These networks 560 may communicate with a LAN to reach users. The user interface may include a web browser or a software application that facilitates communication between the user and remote data. Such software applications have been referred to as “thin” desktop software applications or “thin clients.” Thin clients typically incorporate software programs to emulate desktop sessions. Mobile device software applications can also be used. Remote servers 580 can also host remote databases 581, with the database located on one remote server 580 or distributed across multiple remote servers 580. Remote databases 581 are accessible from database client applications installed locally on the remote server 580, other remote servers 580, user devices 561, or computer system 501 across a network 560. An AI/ML model described or depicted here may reside fully or partially on any of the elements described or depicted in FIG. 5.

Although an exemplary example of the instant solution of at least one of an apparatus, method, and computer readable medium has been illustrated in the accompanying drawings and described in the foregoing detailed description, it will be understood that the instant solution is not limited to the examples of the instant solution disclosed but is capable of numerous rearrangements, modifications, and substitutions as set forth and defined by the following claims. For example, the instant solution's capabilities of the various figures can be performed by at least one of the modules or components described herein or in a distributed architecture and may include a transmitter, receiver, or pair of both. For example, all or part of the functionality performed by the individual modules may be performed by at least one of these modules. Further, the functionality described herein may be performed at various times and in relation to various events, internal or external to the modules or components. Also, the information sent between various modules can be sent between the modules via at least one of a data network, the Internet, a voice network, an Internet Protocol network, a wireless device, a wired device and/or via a plurality of protocols. Also, the messages sent or received by any of the modules may be sent or received directly and/or via at least one of the other modules.

One skilled in the art will appreciate that the instant solution may be embodied as a personal computer, a server, a console, a personal digital assistant (PDA), a cell phone, a tablet computing device, a smartphone, or any other suitable computing device, or combination of devices. Presenting the above-described functions as being performed by the instant solution is not intended to limit the scope of the present instant solution in any way but is intended to provide one example of the many examples of the instant solution. Indeed, methods, systems, and apparatuses disclosed herein may be implemented in localized and distributed forms consistent with computing technology.

It should be noted that some of the instant solution features described in this specification have been presented as modules in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise at least one physical or logical block of computer instructions that may, for instance, be organized as an object, procedure, or function. Nevertheless, the executables of an identified module may not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory, tape, or any other such medium used to store data.

Indeed, a module of executable code may be a single instruction or many instructions and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations, including over different storage devices, and may exist, at least partially, merely as electronic signals on a system or network.

It will be readily understood that the components of the instant solution, as generally described and illustrated in the figures herein, may be arranged and designed in a wide variety of different configurations. Thus, the detailed descriptions of the instant solution and the examples and features of the instant solution are not intended to limit the scope of the instant solution as claimed but are merely representative examples of the instant solution.

One having ordinary skill in the art will readily understand that the above may be practiced with steps in a different order and/or with hardware elements in configurations that are different from those which are disclosed. Therefore, although the instant solution has been described based upon these preferred examples and features of the instant solution, it would be apparent to those of skill in the art that certain modifications, variations, and alternative constructions would be apparent.

While preferred examples of the present instant solution have been described, it is to be understood that the examples described are illustrative, and the scope of the instant solution is to be defined solely by the appended claims when considered with a full range of equivalents and modifications (e.g., protocols, hardware devices, software platforms, etc.) thereto.

The instant solution delivers a technically grounded and computationally efficient method for dataset compression tailored for training high-performance image classifiers. A practical application is associated with the leveraging of a transformer-based encoder trained on annotated image-text data where both a source dataset (annotated) and a target dataset (unannotated) are converted into latent vector representations that preserve semantic and structural features of each sample. These latent vectors are processed through a pairwise similarity matrix to identify relationships between data points, with a similarity graph constructed where nodes represent source latents and edges connect similar pairs that exceed a defined threshold. This structure enables the system to isolate clusters of closely related samples, which often correspond to semantically redundant or distributionally similar images within the annotated dataset. Within each cluster, a divergence classifier, previously trained to distinguish between the statistical characteristics of the source and target domains, is employed to score each sample based on its alignment with the target dataset's distribution. Only the top-scoring samples from each cluster are retained, forming a reduced dataset that is both compact and domain-representative.

The reduced dataset is subsequently passed to a model training module, where it is used in combination with the target dataset to train an image classifier. This classifier benefits from exposure to samples that are not only diverse but also statistically optimized to reflect the target domain's characteristics. As a result, the trained model exhibits improved generalization performance and robustness to domain shift, while requiring substantially fewer resources and training iterations than models trained on full, unfiltered datasets. The reduced computational burden also translates into cost savings and faster deployment timelines, making the solution particularly valuable in environments with limited computer resources or time-sensitive inference demands. This compression and optimization process ensures that the trained classifier maintains high accuracy without being overfit to noisy or redundant examples, a common problem in large-scale annotation efforts.

When deployed, the resulting image classifier can be integrated into real-time or batch inference workflows, including those that involve domain-specific tasks such as visual prompt classification in chatbot systems or content moderation pipelines.

In a practical deployment, a data scientist or machine learning engineer interacts with the instant solution through a graphical user interface (GUI) or an API-enabled service dashboard. The operator may begin by uploading an annotated dataset, comprising labeled images, and optionally providing a second, unlabeled dataset representative of a target domain. Upon initiating the processing pipeline, the system encodes both datasets into latent vectors using a preconfigured transformer encoder. The operator can visualize these latent encodings as similarity distributions or cluster diagrams through the user interface, allowing inspection of how annotated samples relate to the target data distribution.

The interface allows the operator to adjust similarity thresholds that govern the graph construction process, providing granular control over the balance between dataset compression and representational coverage. As clusters are formed and divergence scores are calculated, the operator may review scoring metrics to understand which samples are retained or excluded. In cases where specific samples are misclassified or omitted, the operator can intervene by flagging these for inclusion or removal through the feedback interface. This feedback is stored and may be used in a subsequent retraining loop to further refine the selection logic and classifier behavior.

Once a reduced dataset is generated, the operator has the option to export it for manual inspection or to trigger downstream training of a classifier using the curated subset. During and after training, the user may compare performance metrics, such as validation accuracy or inference latency, between the reduced model and a baseline trained on the full dataset. These comparisons assist the operator in quantifying the efficiency gains and validating the representational fidelity of the compressed dataset. The operator can deploy the trained model to production systems and monitor its behavior in live environments. The solution's logging and feedback tools enable real-time capture of model outputs and user corrections, empowering the operator to continuously adapt the model by incorporating newly flagged examples.

What is claimed is:

1. A system, comprising:
a memory; and
at least one processor communicatively coupled to the memory, wherein the at least one processor is configured to:
determine first latents for a first dataset stored in the memory and second latents for a second dataset stored in the memory that uses a transformer encoder trained on annotated image-text data;
generate a similarity matrix based on comparisons between the first latents and the second latents;
construct a graph comprising nodes that corresponds to the first latents and edges based on pairwise similarity that exceeds a threshold;
identify connected components in the graph and select, from each component, at least one latent that has a highest score from a classifier trained to approximate divergence between the first dataset and the second dataset;
form a reduced dataset comprising the at least one latent;
provide the reduced dataset to a model training module; and
train an image classifier that uses the reduced dataset and the second dataset.

2. The system of claim 1, wherein the at least one processor is configured to generate the similarity matrix that compares each of the first latents to each of the second latents that uses a feature-based similarity scoring function.

3. The system of claim 1, wherein the at least one processor is configured to construct the graph by an omission of edges between latents whose pairwise similarity is below a defined similarity threshold.

4. The system of claim 1, wherein the classifier is a binary neural network trained to differentiate distributions based on divergence between the first dataset and the second dataset.

5. The system of claim 1, wherein the at least one processor is configured to select a latent from each connected component by rank of latents within each component based on divergence probability scores and select a top-scoring latent.

6. The system of claim 1, wherein the at least one processor is further configured to receive an image that belongs to the second dataset from a user device and encode the image into a second latent that uses the transformer encoder.

7. The system of claim 1, wherein the at least one processor is further configured to receive, via a user interface on a computing device, a feedback signal that selects an incorrectly classified image from the reduced dataset, and remove the incorrectly classified image from the train.

8. The system of claim 1, wherein the at least one processor is further configured to transmit the image classifier to a user device for local inference after training is completed that uses the reduced dataset and the second dataset.

9. The system of claim 1, wherein the second dataset comprises prompt messages received by a chatbot service, and the image classifier assigns content moderation or routing labels to received chatbot messages based on visual context or associated imagery.

10. A method, comprising:
determining, by a transformer encoder trained on annotated image-text data, first latents for a first dataset stored in a memory, and second latents for a second dataset stored in the memory;
generating a similarity matrix based on comparisons between the first latents and the second latents;
constructing a graph comprising nodes corresponding to the first latents and edges based on pairwise similarity exceeding a threshold;
identifying connected components in the graph and selecting, from each component, at least one latent having a highest score from a classifier trained to approximate divergence between the first dataset and the second dataset;
forming a reduced dataset comprising the at least one latent;
providing the reduced dataset to a model training module; and
training an image classifier using the reduced dataset and the second dataset.

11. The method of claim 10, wherein generating the similarity matrix comprises comparing each of the first latents to each of the second latents using a feature-based similarity scoring function.

12. The method of claim 10, wherein constructing the graph further comprises omitting edges between latents whose pairwise similarity is below a defined similarity threshold.

13. The method of claim 10, wherein the classifier is a binary neural network trained to differentiate distributions based on divergence between the first dataset and the second dataset.

14. The method of claim 10, wherein selecting a latent from each connected component comprises ranking latents within each component based on divergence probability scores and selecting a top-scoring latent.

15. The method of claim 10, further comprising receiving, from a user device, an image belonging to the second dataset and encoding the image into a second latent using the transformer encoder.

16. The method of claim 10, further comprising receiving, via a user interface on a computing device, a feedback signal selecting an incorrectly classified image from the reduced dataset, wherein the incorrectly classified image is removed from the training.

17. The method of claim 10, further comprising transmitting the image classifier to a user device for local inference after training is completed using the reduced dataset and the second dataset.

18. The method of claim 10, wherein the second dataset comprises prompt messages received by a chatbot service, and the image classifier assigns content moderation or routing labels to incoming chatbot messages based on visual context or associated imagery.

19. A computer program product, comprising:
at least one computer-readable storage media; and
program instructions stored on the at least one computer-readable storage media to perform operations comprising:
determining, by a transformer encoder trained on annotated image-text data, first latents for a first dataset stored in a memory, and second latents for a second dataset stored in the memory;
generating a similarity matrix based on comparisons between the first latents and the second latents;
constructing a graph comprising nodes corresponding to the first latents and edges based on pairwise similarity exceeding a threshold;
identifying connected components in the graph and selecting, from each component, at least one latent having a highest score from a classifier trained to approximate divergence between the first dataset and the second dataset;
forming a reduced dataset comprising the at least one latent;
providing the reduced dataset to a model training module; and
training an image classifier using the reduced dataset and the second dataset.

20. The computer program product of claim 19, wherein generating the similarity matrix comprises comparing each of the first latents to each of the second latents using a feature-based similarity scoring function.
